(19) United States
(12) Patent Application Publication
(10) Pub. No.: US 2026/0371141 A1
(43) Pub. Date: Nov. 19, 2026

(54) REPORTING METRICS

(71) Applicant: QUALCOMM Incorporated, San Diego, CA (US)

(72) Inventors: Aria HASANZADEZONUZY, Chatham, NJ (US); Navid ABEDINI, Basking Ridge, NJ (US); Tao LUO, San Diego, CA (US); Wenjun LI, Basking Ridge, NJ (US)

(21) Appl. No.: 19/673,527

(22) Filed: May 11, 2026

Related U.S. Application Data
(60) Provisional application No. 63/805,028, filed on May 13, 2025.

(51) Int. Cl. H04W 24/10; H04W 36/36

(52) U.S. Cl. CPC H04W 24/10; H04W 36/362

(57) ABSTRACT

Certain aspects of the present disclosure provide techniques for wireless communications. An example method includes receiving a configuration that indicates a reporting metric for a measurement report, the reporting metric comprising at least one of: a rate of change for a parameter, a range of values of the parameter, a frequency of threshold exceedance for the parameter, or a function output based on the parameter; and transmitting the measurement report in accordance with the configuration.

### CROSS-REFERENCE TO RELATED APPLICATION(S)

The present Application for Patent claims benefit of U.S. Provisional Application No. 63/805,028, filed May 13, 2025, which is hereby expressly incorporated by reference herein in its entirety.

### INTRODUCTION

### Field of the Disclosure

Aspects of the present disclosure relate to wireless communications, and more particularly, to techniques for reporting metrics.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a wireless communication device. The method includes receiving a configuration that indicates a reporting metric for a measurement report, the reporting metric comprising at least one of: a rate of change for a parameter, a range of values of the parameter, a frequency of threshold exceedance for the parameter, or a function output based on the parameter; and transmitting the measurement report in accordance with the configuration.

Certain aspects provide a method for wireless communications by a network entity. The method includes transmitting, to a wireless communication device, a configuration that indicates a reporting metric for a measurement report, the reporting metric comprising at least one of: a rate of change for a parameter, a range of values of the parameter, a frequency of threshold exceedance for the parameter, or a function output based on the parameter; receiving the measurement report in accordance with the configuration; and generating, using an artificial intelligence or machine learning (AI/ML) functionality, an inference based on the measurement report.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating an example of signaling between a network entity and a wireless communication device.

FIG. 6 depicts a method for wireless communications.

FIG. 7 depicts another method for wireless communications.

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for reporting metrics.

A wireless network may support reporting of certain measurements or parameters. Traditionally, such reporting has been configured with regard to a specific measurement (such as a reference signal received power (RSRP) measured on a particular resource or reference signal), a time-averaged measurement (such as a Layer 3 RSRP, which is a time-filtered RSRP value based on multiple RSRP measurements), or channel state information derived from one or more measurements. Measurement reporting is useful for a variety of use cases, such as performance monitoring, mobility management, load balancing, radio resource management, interference mitigation, and quality of service (QoS) management. Some forms of reporting also relate to network usage metrics, such as QoS flow performance, buffer status reporting, and power headroom reporting.

As wireless networks evolve, a network entity may implement increasingly complex functionalities that benefit from or require increasingly complex input data. For example, a network entity may be equipped with a predictive algorithm. This algorithm may involve techniques such as stochastic modeling, artificial intelligence, or machine learning. The algorithm could forecast future traffic patterns based on previous traffic loads, estimate future signal strength by analyzing historical signal data, or the like. Some potential applications of these algorithms include enhancing resource utilization within the serving cell (the cell to which the UE is connected) or improving the mobility of connected devices within the network.

As mentioned, such functionalities may benefit from complex input data or input data that is richer than traditional forms of measurement reporting. For example, to facilitate a more informed decision that improves the performance of both the UE and the network, the network may benefit from more frequent measurements or observations and/or reports from the UE to input to a predictive algorithm. However, such measurements and reports may consume power and communication resources at the UE. A technical challenge is to find a suitable UE reporting scheme while maintaining efficient UE operation with respect to measurement or reporting.

As a particular example, consider the context of connected-mode mobility of a UE, in which a decision is made to add or switch cells or cell groups of a UE. A primary reason for the mobility could be to make sure the UE is connected to the “best” cell as the UE moves through the system. Thus, decisions regarding connected-mode mobility may be primarily based on channel quality/strength (like RSRP). However, there are other example use-cases for mobility procedures and decisions, such as network energy savings (e.g., a gNB may wish to shut down a cell for energy savings, and may thus need to move associated UEs to another cell) or load balancing (e.g., better distribute load across cells or gNBs, or some UEs may need to be served by other cells or gNBs). Such decisions may need to be evaluated carefully to ensure that they do not incur higher overall network energy consumption, unbalanced load, and/or cause undesirable impacts to UEs (e.g., unable to maintain a minimum QoS). Apart from traditional neighbor cell measurements (e.g., RSRP-based), which may be insufficient to estimate the UE's achievable data rate on a target neighbor cell, more information may be beneficial to better capture (and predict) the UE's needs and performance, and the UE's impact on the network.

Aspects of the present disclosure relate generally to measurement reporting (or more generally, transmission of a report based on a reporting metric) to facilitate reporting of more frequent measurements (or more frequent reporting of measurements) relative to traditional measurement reporting regimes. A wireless communication device, such as a UE or a network entity (e.g., a gNB, a distributed unit) may receive a configuration. The configuration may indicate a reporting metric for a measurement report. The reporting metric may be based on a parameter, such as a buffer status, a traffic demand, a path loss, a delay status, a channel quality indicator (CQI), an RSRP, an SINR, a reference signal received quality (RSRQ), a throughput, or the like.

In some aspects, the reporting metric comprises a rate of change for the parameter. Reporting the rate of change (or reporting based on the rate of change) may provide insight into how the parameter changes over time, aiding in the forecasting of future values. For example, the rate of change may represent a measured rate of change within a specified time frame (e.g., +0.2 dBm per second). As another example, the rate of change could indicate a projected rate of change for a forthcoming indicated or configured time period.

In some aspects, the reporting metric comprises a range of values of the parameter (e.g.,−19 to −23 dBm). The range of values captures the variability of these metrics, which supports robust design with inherent margins. For example, the range of values may represent a measured range of values. As another example, the range of values could indicate a projected range of values for a forthcoming indicated or configured time period.

In some aspects, the reporting metric comprises a frequency of threshold exceedance for the parameter (e.g., “the parameter has exceeded a threshold X times in a reporting window”). This information provides the gNB with a more complete understanding of UE channel and traffic fluctuations, facilitating both opportunistic and dependable designs. For example, the frequency of threshold exceedance may represent a measured frequency of threshold exceedance. As another example, the frequency of threshold exceedance could indicate a projected frequency of threshold exceedance for a forthcoming indicated or configured time period.

In some aspects, the reporting metric comprises a function output based on the parameter. The function output may be based on a linear combination with specific coefficients (e.g., any type of filtering such as an averaging), a variance, a Fourier transform, or the like. This type of reporting metric could help the UE to better summarize the history of a parameter of interest (e.g., RSRP), and may help the network entity to speed up its operations since the UE is performing operations related to summarizing the history of the parameter.

Thus, reporting by a UE or network entity of more rich measurement information (e.g., relative to traditional reporting) is provided while maintaining efficient UE operation with respect to measurement or reporting.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

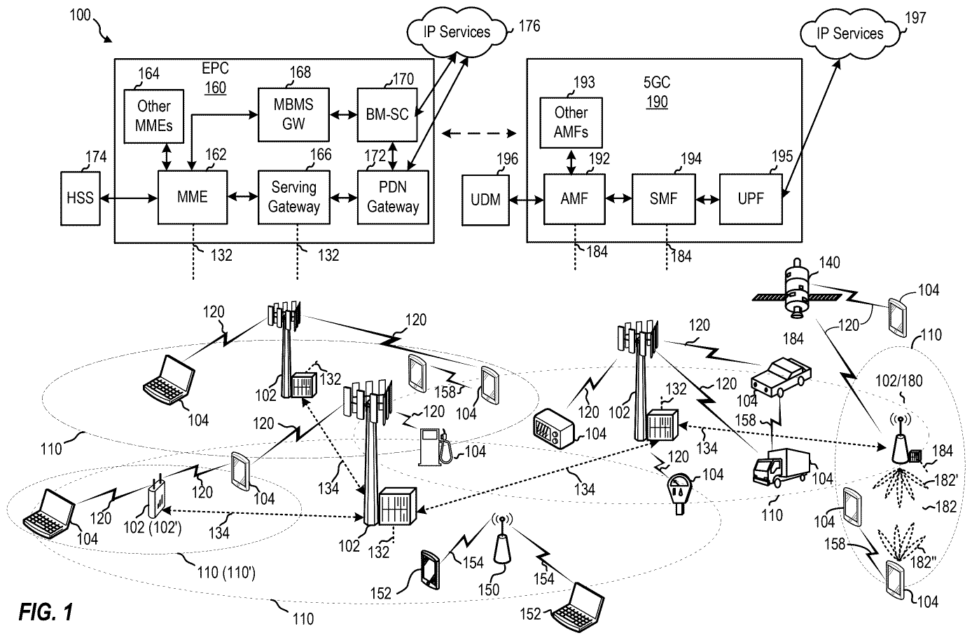

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

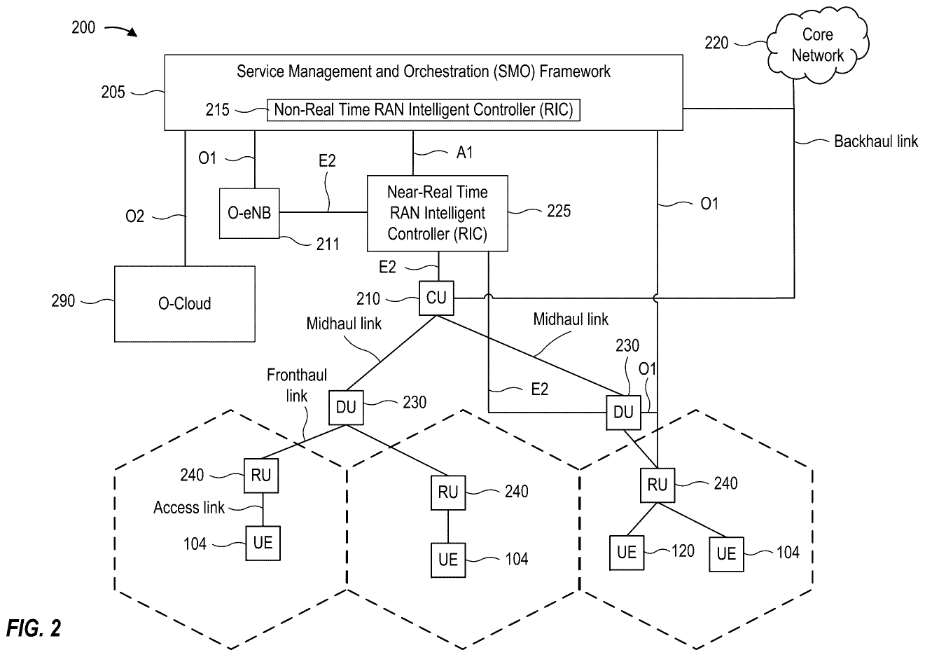

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S 1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communications link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

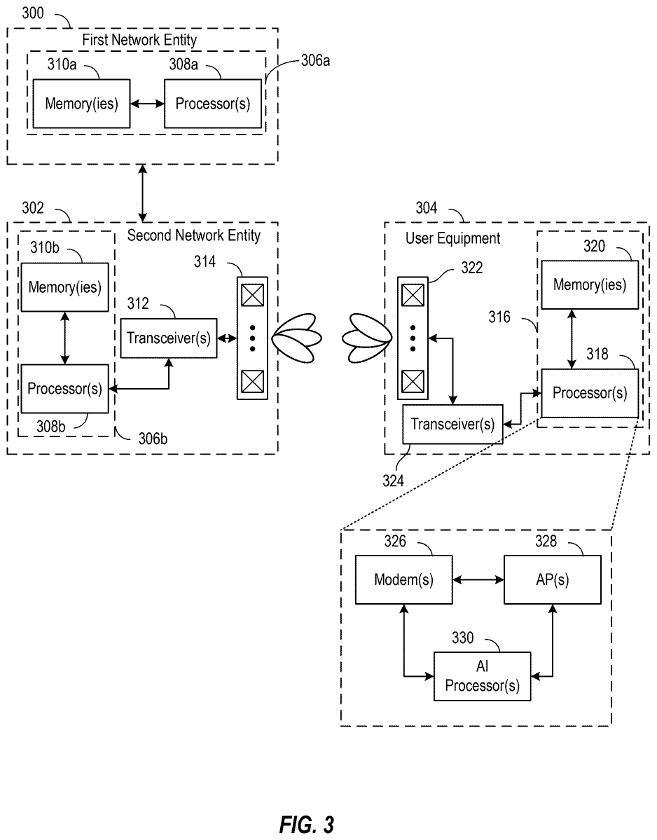

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

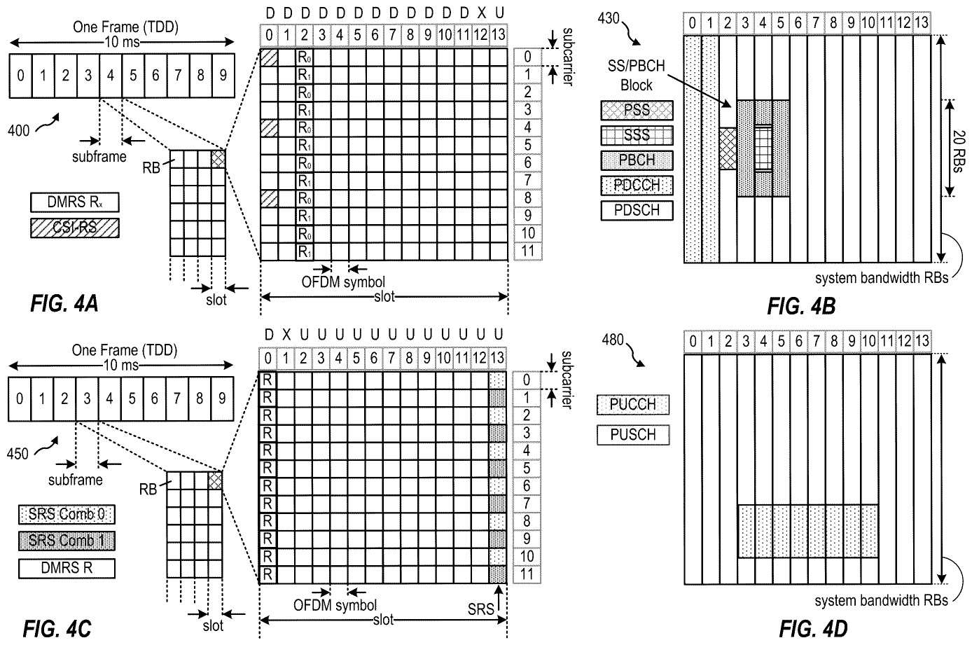

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

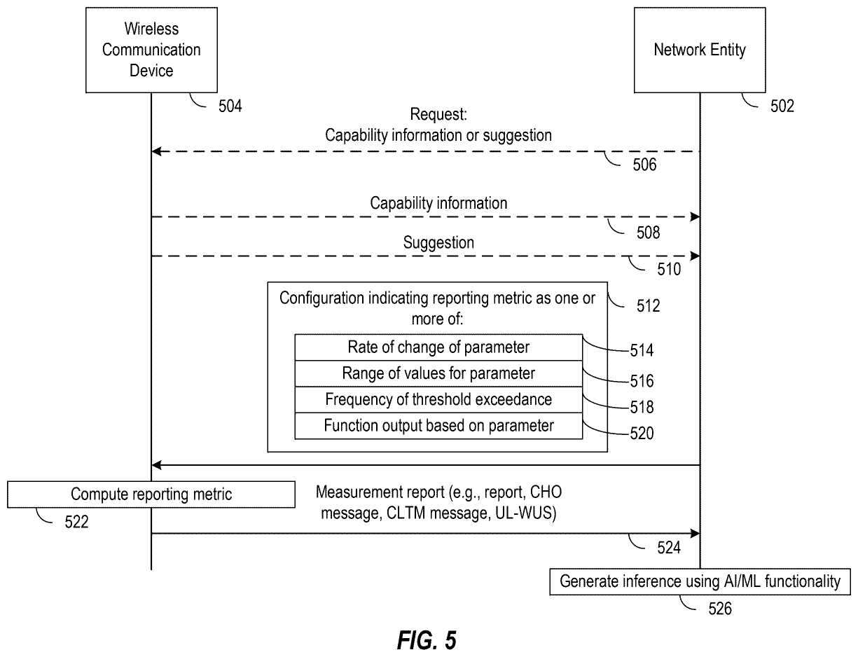

FIG. 5 is a diagram illustrating an example 500 of signaling between a network entity 502 and a wireless communication device 504. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. In some aspects the wireless communication device 504 may be an example of UE 104 depicted and described with respect to FIG. 1 or the UE 304 depicted and described with respect to FIG. 3. In some aspects, the wireless communication device 504 may be an example of the BS 102 depicted and described with respect to FIG. 1, the first network entity 300 or the second network entity 302 depicted and described with respect to FIG. 3, or one or more elements of a disaggregated base station depicted and described with respect to FIG. 2 However, in other aspects, wireless communication device 504 may be another type of wireless communications device and network entity 502 may be another type of network entity or network node, such as those described herein. Note that any operations or signaling illustrated with dashed lines may indicate that that operation or signaling is an optional or alternative example.

As shown at 506, in some aspects, the network entity 502 may transmit, and the wireless communication device 504 may receive, a request. In some aspects, the request may be a request for capability information for the measurement report. Additionally, or alternatively, the request may be for a suggestion. Each is described in turn below.

At 508, the wireless communication device 504 may transmit, and the network entity 502 may receive, the capability information. In some aspects, the wireless communication device 504 may transmit the capability information in response to the request at 506. The capability information may indicate capabilities of the wireless communication device 504. For example, the capability information may indicate a capability regarding calculation of the reporting metric (e.g., a capability regarding stochastic characteristic calculation). In some aspects, the capability information may be specific to a frequency (e.g., a component carrier, a bandwidth part, a band), a reference signal type (e.g., sounding reference signal, channel state information reference signal, synchronization signal block), or the like. If the wireless communication device 504 reports capability information at 508, the configuration at 512 may be in accordance with the capability information (e.g., may indicate a reporting metric, reference signal, target time parameter, target frequency parameter, or target spatial parameter that is within capabilities of the wireless communication device 504).

At 510, the wireless communication device 504 may transmit, and the network entity 502 may receive, the suggestion. In some aspects, the wireless communication device 504 may transmit the suggestion in response to the request at 506. Alternatively, the wireless communication device 504 may transmit the suggestion without receiving the request at 506. The suggestion may indicate a suggestion for the reporting metric. For example, the suggestion may indicate that the wireless communication device 504 can provide a range of values for one or more reporting metrics. As another example, the request at 506 may indicate a range of values for a reporting metric, and the suggestion at 510 may indicate a selected value from the range of values. Providing the suggestion may be particularly beneficial for a wireless communication device 504 that is a network entity, suggesting reporting metrics to another network entity 502. Furthermore, the suggestion at 510 may be beneficial when the wireless communication device 504 cannot implement a particular configuration or reporting metric despite supporting the particular configuration or reporting metric (for example, due to loading at the UE or a low battery level).

At 512, the network entity 502 transmits, and the wireless communication device 504 receives, a configuration. The network entity 502 may transmit the configuration via any suitable form of signaling, such as radio resource control (RRC) signaling, system information, medium access control signaling, downlink control information, backhaul/midhaul/fronthaul signaling such as Xn signaling (e.g., if the network entity 502 and the wireless communication device 504 are CUs) or F1 application protocol signaling (e.g., if one of the network entity 502 and the wireless communication device 504 is a CU and the other is a DU), or the like. Signaling via the backhaul, midhaul, or fronthaul may be particularly beneficial in a scenario where a connected wireless communication device 504 (e.g., UE) is transferred from a first cell associated with a first cell site to a target cell associated with a second cell site. For example, the target cell may benefit from a reporting metric configured at 512, such as to determine a downlink load associated with the wireless communication device 504, and may transmit the configuration to the source cell to obtain the downlink load as a reporting metric.

The configuration may indicate a reporting metric or any combination of two or more reporting metrics. A reporting metric is related to a parameter. For example, a reporting metric may indicate a metric, derived from the parameter, that the wireless communication device 504 is to report (or is to transmit a signal based on). Examples of reporting metrics are provided at 514, 516, 518, and 520, which are described in turn below. Examples of parameters are provided after the examples of reporting metrics.

As shown at 514, in some aspects, the reporting metric comprises a rate of change for the parameter. Reporting the rate of change (or reporting based on the rate of change) may provide insight into how the parameter changes over time, aiding in the forecasting of future values. For example, the rate of change may represent a measured rate of change within a specified time frame (e.g., +0.2 dBm per second). As another example, the rate of change could indicate a projected rate of change for a forthcoming indicated or configured time period.

As shown at 516, in some aspects, the reporting metric comprises a range of values of the parameter (e.g., −19 to −23 dBm). The range of values captures the variability of these metrics, which supports robust design with inherent margins. For example, the range of values may represent a measured range of values. As another example, the range of values could indicate a projected range of values for a forthcoming indicated or configured time period.

As shown at 518, in some aspects, the reporting metric comprises a frequency of threshold exceedance for the parameter (e.g., “the parameter has exceeded a threshold X times in a reporting window”). This information provides the gNB with a more complete understanding of UE channel and traffic fluctuations, facilitating both opportunistic and dependable designs. For example, the frequency of threshold exceedance may represent a measured frequency of threshold exceedance. As another example, the frequency of threshold exceedance could indicate a projected frequency of threshold exceedance for a forthcoming indicated or configured time period.

As shown at 520, in some aspects, the reporting metric comprises a function output based on the parameter. The function output may be based on a linear combination with specific coefficients (e.g., any type of filtering such as an averaging), a non-linear combination, a variance, a Fourier transform, or the like. This type of reporting metric could help the UE to better summarize the history of a parameter of interest (e.g., RSRP), and may help the network entity to speed up its operations since the UE is performing operations related to summarizing the history of the parameter.

Configuring the reporting metric for reporting enables wireless communication devices to incorporate new reporting metrics for any parameter that the network entity may use for decision-making. For instance, parameters derived from a UE's CSI-RS measurements may be utilized for modulation and coding scheme (MCS) and/or precoding matrix indicator (PMI) determination, or for assessing load status related to mobility decisions. Reporting metrics configured as described herein can effectively encapsulate the dynamic nature of these parameters over time. Thus, in some examples, the parameter may comprise (or the reporting metric may be determined based on) a proper subset of parameters (e.g., less than all parameters, such as a proper subset selected from the set including CQI, RI, LI, and PMI) of a CSI report. Consequently, for MCS and/or PMI determination, the wireless communication device 504 (e.g., UE) is not required to transmit extensive CSI-RS measurement reports. Similarly, for mobility decisions, network entity 502 and wireless communication device 504 (e.g., another network entity) do not need to frequently exchange load data, and can instead exchange a reporting metric derived from the load data. This type of report can serve as an input for the network entity 502's algorithms at 526, leading to improved decision-making.

In some aspects, the reporting metric is based on a target frequency parameter. The target frequency parameter may indicate a frequency component for which the wireless communication device 504 is to compute the reporting metric. For example, the target frequency parameter may include a cell, a component carrier, a bandwidth part, a sub-band, or the like. In some aspects, the reporting metric is based on a target spatial parameter. The target spatial parameter may indicate a spatial component for which the wireless communication device 504 is to compute the reporting metric. For example, the target spatial parameter may include a beam, a reference signal, a transmission configuration indicator (TCI) state, a synchronization signal block (SSB) index corresponding to a beam, or the like. In some aspects, the reporting metric is based on a target time parameter. The target time parameter may indicate a time component for which the wireless communication device 504 is to compute the reporting metric. For example, the target time parameter may include an instantaneous time or a time window, and the reporting metric may be computed based on the parameter as measured or determined in accordance with the target time parameter. As an example of a reporting metric based on one or more target frequency parameters, one or more target time parameters, and/or one or more target spatial parameters, the wireless communication device 504 may be configured to compute an average of pathloss over a time interval (which is a target time parameter), a sub-band (which is a target frequency parameter), an SSB beam (which is a target spatial parameter), or a combination thereof. As another example, a reporting metric that indicates traffic demand history may be logged by a modem of the wireless communication device 504 (e.g., UE) and reported accordingly. Alternatively, the traffic demand history may be logged by a wireless communication device 504 that is a serving cell of a UE, and may be reported to the network entity 502 (where the network entity 502 is responsible for cell activation or deactivation commands).

In some aspects, the configuration may indicate the parameter to which the reporting metric relates. The parameter may include any number of parameters, such as a buffer status (e.g., a value indicating the amount of data queued in a transmit buffer awaiting transmission), traffic demand (e.g., quantity of data transmission requirements from users or applications that must be satisfied within a specific time period), path loss (e.g., attenuation of radio frequency signal power between the transmitter and receiver), delay status (e.g., metric indicating an amount of time left in a permitted delay for a transmission), a channel quality indicator (CQI) (e.g., a feedback metric that represents the estimated quality of the downlink channel), RSRP, RSRQ, throughput, or the like.

In some aspects, the configuration indicates how to calculate the reporting metric. For example, the configuration may indicate a target frequency parameter, a target time parameter, and/or a target spatial parameter, as described above. As another example, the configuration may indicate a threshold associated with the frequency of threshold exceedance (e.g., a threshold that, when satisfied, causes the wireless communication device 504 to increment or modify the frequency of threshold exceedance). As another example, the configuration may indicate a quantity of occurrences, such as a maximum occurrence count or a minimum occurrence count, for a reporting metric (e.g., a minimum quantity of occurrences of a condition after which the wireless communication device 504 is configured to calculate or report the reporting metric). As another example, the configuration may indicate a range of interest (e.g., a range of values for which the wireless communication device 504 is configured to calculate or report the reporting metric). As another example, the configuration may indicate a function for the function output. For example, the configuration may indicate a function that is configured at the wireless communication device 504 prior to receiving the configuration (e.g., pre-configured). As another example, the configuration may indicate a set of coefficients for the function. As another example, the configuration may indicate a type of sample for the parameter. A type of sample may include a time-domain sample, a frequency-domain sample, a TCI state, or the like. The type of sample may indicate the domain in which the wireless communication device 504 is to compute the reporting metric. For example, if the wireless communication device 504 is to compute throughput across a range of different frequencies, the type of sample may indicate “frequency-domain sample” and the configuration may further indicate the range of frequencies. Any of these aspects of the configuration (indicating how to calculate the reporting metric) may be configured to be specific to a frequency (e.g., cell, carrier, sub-band, bandwidth part), beam, time interval, or the like.

In some aspects, the configuration indicates that computation of the reporting metric is aperiodic. An aperiodic computation may be triggered by a trigger, which may be a condition at the wireless communication device 504 or a signal received by the wireless communication device 504 (e.g., from the network entity 502). The configuration may indicate the trigger. The network entity 502 may transmit the trigger (or the wireless communication device 504 may determine that the trigger is received or detected), and the wireless communication device 504 may compute the reporting metric at 520 in accordance with the trigger and the configuration.

In some aspects, the configuration indicates that computation of the reporting metric is semi-persistent. A semi-persistent computation may be activated by a trigger, which may be a condition at the wireless communication device 504 or a signal received by the wireless communication device 504 (e.g., from the network entity 502), and may be performed periodically until deactivated. The configuration may indicate the trigger. The configuration may indicate a periodicity for the semi-persistent computation. The network entity 502 may transmit the trigger (or the wireless communication device 504 may determine that the trigger is received or detected), and the wireless communication device 504 may compute the reporting metric at 520 (e.g., periodically) in accordance with the trigger and the configuration.

In some aspects, the configuration indicates that the computation of the reporting metric is periodic. A periodic computation may be performed periodically until deactivated or de-configured. The configuration may indicate a periodicity for the periodic computation. The wireless communication device 504 may compute the reporting metric at 520 (e.g., periodically) in accordance with the configuration.

The trigger for aperiodic or semi-persistent computation may be signaled via a PDCCH transmission, MAC signaling, or the like. In some aspects, the configuration may indicate a resource for the trigger. A condition that triggers aperiodic or semi-persistent reporting may be based on a condition, also referred to as an event. The event may be based on a threshold, such as an RSRP threshold, an RSRQ threshold, a buffer status report (BSR) threshold, a delay status report (DSR) threshold, or the like, which may be indicated by the configuration.

The configuration of computation of reporting metrics may allow the network entity 502 to configure the wireless communication device 504 to compute the reporting metrics using available parameters (e.g., parameters available at the wireless communication device 504). Consider an example in which the wireless communication device 504 is a connected-mode UE. The UE is connected to a cell with eight SSB beams and is linked to SSB beam1. The network entity 502 has an AI/ML functionality (e.g., at 526) that optimizes user-perceived throughput, and the UE can use multiple TCI states ranging from TCI state 1 to 8. The network entity 502 may configure the UE to provide the following reporting metrics: a maximum and minimum RSRP from SSB beams 2, 3, and 4 over a 160 ms period; a linear combination with predefined coefficients of the instantaneous CQI collected over the designated subbands of the CSI-RS; the average pathloss calculated for the active BWP on TCI state 2 over a duration of 1.28 seconds; and the rate of change in BSR over a 2-second time frame. The wireless communication device 504 may compute these reporting metrics at 520 and may report the reporting metrics at 524. The reporting metrics may serve as input for the network entity's AI/ML functionality at 526 to improve the UE experience.

In some aspects, the configuration may indicate a measurement configuration for the reporting metric, the parameter, or the measurement report. The measurement configuration may indicate whether the wireless communication device 504 is to perform a sub-band granularity measurement or a wideband-granularity measurement to determine the parameter. In some aspects, the configuration may indicate the parameter.

In some aspects, the configuration may indicate how to transmit the measurement report. For example, the configuration may indicate a reporting resource on which to transmit the measurement report (e.g., a physical uplink control channel (PUCCH) resource or a physical uplink shared channel (PUSCH) resource). In some aspects, the configuration may indicate a reporting frequency. The reporting frequency may be aperiodic (e.g., triggered by a signal or an event/condition), semi-persistent (e.g., activated by a signal or an event/condition and transmitted periodically until deactivated), or periodic (e.g., transmitted periodically until deactivated or deconfigured), as described with regard to the computation above.

In some aspects, the configuration may implicitly indicate the reporting metric. For example, the configuration may explicitly indicate to report a CSI-RS RSRP parameter (e.g., for instantaneous or periodic reporting of the CSI-RS RSRP parameter, and the configuration may thus implicitly indicate to report a rate of change of the CSI-RS RSRP parameter. In some aspects, the configuration may implicitly indicate to report the rate of change by indicating a periodicity with which to report the rate of change. More generally, one or more components of the configuration may implicitly indicate the reporting metric. Thus, some configurations for calculating the reporting metric may be indicated implicitly, and any configurations not explicitly indicated may maintain the same value as the original parameter of interest, thereby reducing the burden associated with configuring the calculator or reporting of the reporting metric.

At 522, the wireless communication device 504 computes the reporting metric. For example, the wireless communication device 504 may perform a measurement to determine the parameter or obtain information that indicates the parameter. In some aspects, the wireless communication device 504 may be an entity that has or has access to the parameter used to compute the reporting metric. For example, the network entity 502 may configure the appropriate entity to determine the reporting metric. For instance, a UE may conduct CSI-RS measurements and store the results. It would be advantageous for the UE to assess the rate of change of the CSI-RS RSRP and report this rate of change as a reporting metric. Alternatively, a network entity would have access to downlink load information, making it preferable for the network entity to calculate the ranges of the downlink load experienced by the UE. Either of these may be configured as a wireless communication device 504. The wireless communication device may compute the reporting metric in accordance with the configuration, such as using a function indicated by the configuration, a parameter indicated by the configuration, or according to a periodicity or trigger indicated by the configuration.

At 524, the wireless communication device 504 transmits a measurement report. It should be noted that “measurement report”, as used herein, can refer to various forms of signal or message. For example, the measurement report at 524 may include a message that includes the reporting metric as calculated at the wireless communication device 504. As another example, the measurement report at 524 may be a conditional handover (CHO) message, such as any message exchanged as part of a CHO procedure. As another example, the measurement report at 524 may include a conditional lower-layer triggered mobility (CLTM) message, such as any message exchanged as part of a CLTM procedure. As another example, the measurement report at 524 may include an uplink wakeup signal (UL-WUS), such as a signal that triggers a network entity (e.g., the network entity 502) to enter an awake state or end a low power state. The wireless communication device 504 may transmit the measurement report in accordance with the configuration, such as on a reporting resource indicated by the configuration, in a semi-persistent, periodic, or aperiodic fashion as indicated by the configuration, or the like. Thus, for example, rather than relying solely on the RSRP levels, the rate of change in RSRP could serve as the trigger for the wireless communication device 504 to initiate the CHO process.

In some aspects, as mentioned, the configuration may indicate a condition or event associated with the reporting metric. For example, the condition or event may include a reporting metric (such as a rate of change of a BSR) satisfying a threshold. As another example, the condition or event may include a difference between a first reporting metric and a second reporting metric satisfying a threshold. More generally, the condition or event may be a function of one or more reporting metrics satisfying, or failing to satisfy, a threshold, where any combination of the function, the one or more reporting metrics, or the threshold may be indicated by the configuration at 512.

At 526, the network entity 502 generates an inference using an AI/ML functionality or another form of algorithm such as a stochastic algorithm. For example, the network entity 502 may input, to the AI/ML functionality, the measurement report or information included in the measurement report. In some aspects, the network entity 502 may input information from multiple different measurement reports, such as multiple measurement reports from the wireless communication device 504, measurement reports from different wireless communication devices, or a combination thereof. The inference may include any output of the AI/ML functionality such as (but not limited to) those described elsewhere herein. In some aspects, the network entity 502 may train an AI/ML functionality

Certain aspects described herein may be implemented, at least in part, using some form of AI (e.g., the process of using a ML model to infer or predict output data based on input data). Using an ML model is referred to herein as using an AI/ML functionality. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such as “AI model,” “ML model,” “AI/ML model,” AI/ML functionality,” “trained ML model,” and the like are intended to be interchangeable.

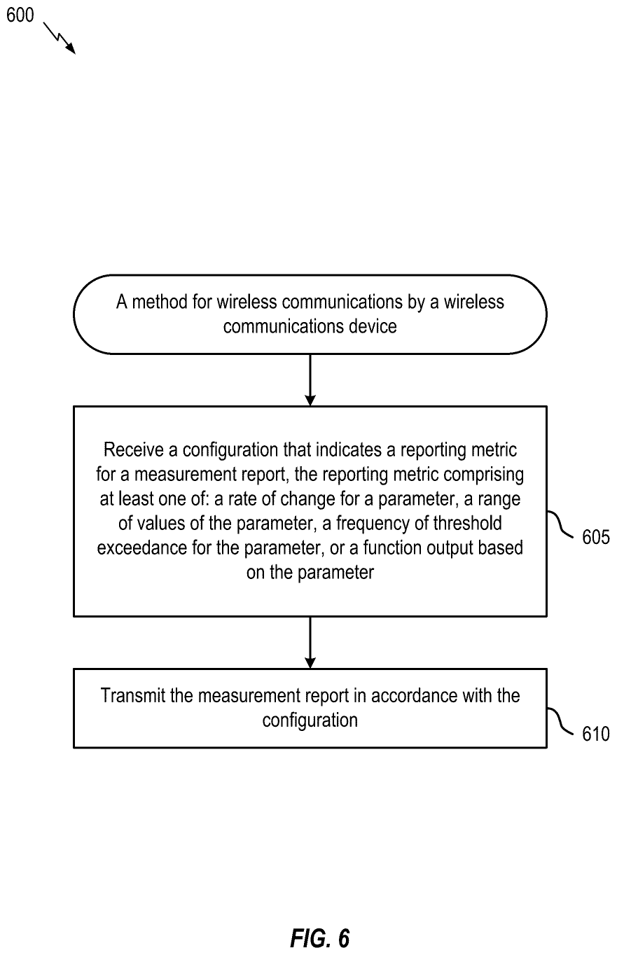

FIG. 6 shows a method 600 for wireless communications by a wireless communication device, such as UE 104 of FIG. 1 or UE 304 of FIG. 3.

Method 600 begins at block 605 with receiving a configuration that indicates a reporting metric for a measurement report, the reporting metric comprising at least one of: a rate of change for a parameter, a range of values of the parameter, a frequency of threshold exceedance for the parameter, or a function output based on the parameter.

Method 600 then proceeds to block 610 with transmitting the measurement report in accordance with the configuration.

In some aspects, the reporting metric is based on one or more of: a target frequency parameter, a target time parameter, or a target spatial parameter.

In some aspects, the reporting metric is based on a proper subset of parameters of a channel state information report.

In some aspects, the configuration indicates, for the reporting metric, at least one of: a target frequency parameter, a target time parameter, a target spatial parameter, the parameter to which the reporting metric relates, a threshold associated with the frequency of threshold exceedance, a quantity of occurrences, a range of interest, a function for the function output, or a type of sample for the parameter.

In some aspects, the configuration indicates a plurality of reporting metrics for the parameter, and wherein the measurement report comprises the plurality of reporting metrics.

In some aspects, the wireless communication device comprises a network entity, and wherein block 605 includes receiving the configuration via a backhaul interface, a midhaul interface, or a fronthaul interface.

In some aspects, the configuration indicates a periodicity for calculation of the reporting metric, and wherein the method 600 further comprises calculating the reporting metric in accordance with the periodicity.

In some aspects, the configuration indicates that calculation of the reporting metric is aperiodic or semi-persistent, and wherein the method 600 further comprises calculating the reporting metric in accordance with a trigger.

In some aspects, method 600 further includes transmitting a suggestion for the measurement metric, wherein the configuration is in accordance with the suggestion.

In some aspects, method 600 further includes receiving a request for the suggestion, wherein transmitting the suggestion comprises transmitting the suggestion in accordance with the request.

In some aspects, method 600 further includes transmitting capability information for the measurement report, wherein the configuration is in accordance with capability information.

In some aspects, method 600 further includes receiving a request for the capability information, wherein transmitting the capability information comprises transmitting the capability information in accordance with the request.

In some aspects, the configuration indicates at least one of: a measurement configuration, a reporting frequency, or a reporting resource for the measurement report.

In some aspects, the configuration explicitly indicates to report the parameter and implicitly indicates to report the reporting metric based on explicitly indicating the parameter.

In some aspects, the measurement report comprises at least one of: a conditional handover message, a conditional lower-layer triggered mobility message, or an uplink wakeup signal.

In some aspects, block 610 includes transmitting the measurement report based on a condition, associated with the reporting metric and indicated by the configuration, being satisfied.

In some aspects, the wireless communication device comprises a UE.

In some aspects, the wireless communication device comprises a network entity.

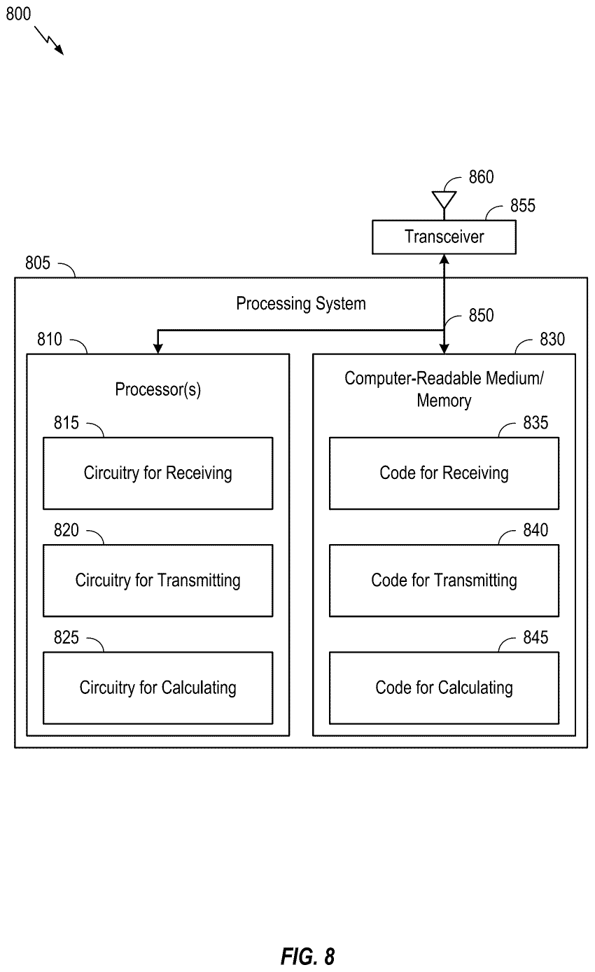

In some aspects, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative operations are possible consistent with this disclosure.

### Example Operations of a Network Entity

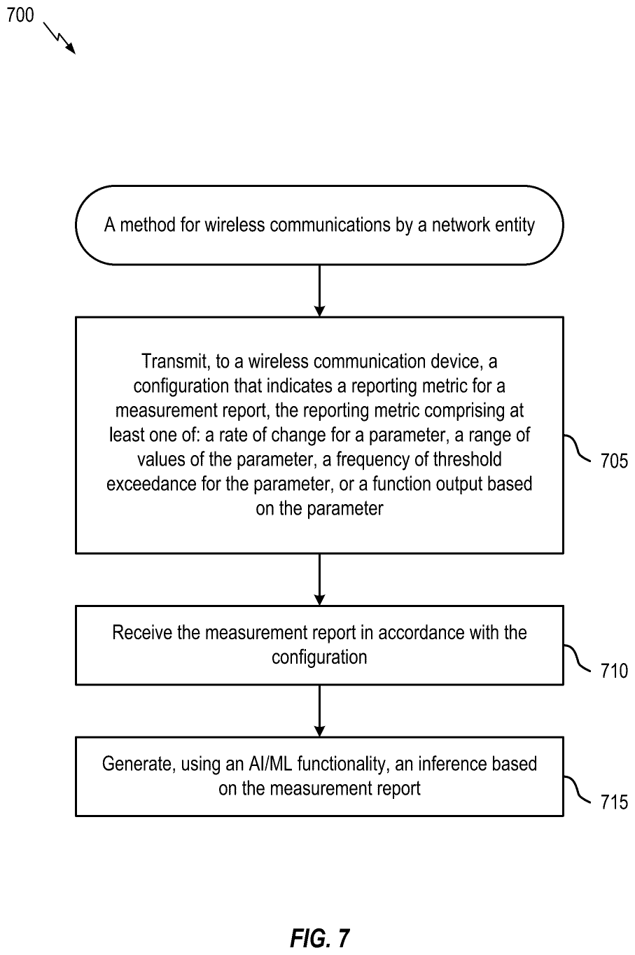

FIG. 7 shows a method 700 for wireless communications by a network entity, such as BS 102 of FIG. 1, a first network entity 300 or second network entity 302 of FIG. 3, or a disaggregated base station as discussed with respect to FIG. 2.

Method 700 begins at block 705 with transmitting, to a wireless communication device, a configuration that indicates a reporting metric for a measurement report, the reporting metric comprising at least one of: a rate of change for a parameter, a range of values of the parameter, a frequency of threshold exceedance for the parameter, or a function output based on the parameter.

Method 700 then proceeds to block 710 with receiving the measurement report in accordance with the configuration.

Method 700 then proceeds to block 715 with generating, using an AI/ML functionality, an inference based on the measurement report.

In some aspects, the reporting metric is based on one or more of: a target frequency parameter, a target time parameter, or a target spatial parameter.

In some aspects, the reporting metric is based on a proper subset of parameters of a channel state information report.

In some aspects, the configuration indicates, for the reporting metric, at least one of: a target frequency parameter, a target time parameter, a target spatial parameter, the parameter to which the reporting metric relates, a threshold associated with the frequency of threshold exceedance, a quantity of occurrences, a range of interest, a function for the function output, or a type of sample for the parameter.

In some aspects, the configuration indicates a plurality of reporting metrics for the parameter, and wherein the measurement report comprises the plurality of reporting metrics.

In some aspects, the wireless communication device comprises a second network entity, and wherein block 705 includes transmitting the configuration via a backhaul interface, a midhaul interface, or a fronthaul interface.

In some aspects, the configuration indicates a periodicity for calculation of the reporting metric.

In some aspects, the configuration indicates that calculation of the reporting metric is aperiodic or semi-persistent, and wherein the method 700 further comprises transmitting a trigger for calculation of the reporting metric.

In certain aspects, method 700 further includes receiving a suggestion for the measurement metric, wherein the configuration is in accordance with the suggestion.

In certain aspects, method 700 further includes transmitting a request for the suggestion, wherein receiving the suggestion comprises receiving the suggestion in accordance with the request.

In certain aspects, method 700 further includes receiving capability information for the measurement report, wherein the configuration is in accordance with capability information.

In certain aspects, method 700 further includes transmitting a request for the capability information, wherein receiving the capability information comprises receiving the capability information in accordance with the request.

In some aspects, the configuration indicates at least one of: a measurement configuration, a reporting frequency, or a reporting resource for the measurement report.

In some aspects, the configuration explicitly indicates to report the parameter and implicitly indicates to report the reporting metric based on explicitly indicating the parameter.

In some aspects, the measurement report comprises at least one of: a conditional handover message, a conditional lower-layer triggered mobility message, or an uplink wakeup signal.

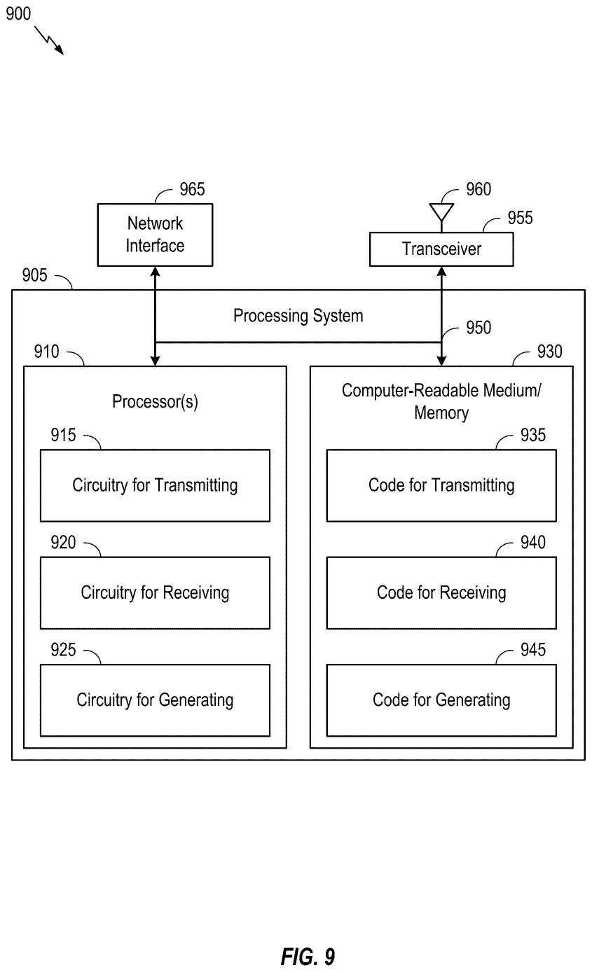

In some aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

### Example Communications Devices

FIG. 8 depicts aspects of an example communications device 800 configured for wireless communications. In some aspects, communications device 800 is a user equipment, such as UE 104 described above with respect to FIG. 1 or UE 304 described with respect to FIG. 3.

The communications device 800 includes a processing system 805 coupled to a transceiver 855 (e.g., a transmitter and/or a receiver). The transceiver 855 is configured to transmit and receive signals for the communications device 800 via an antenna 860, such as the various signals as described herein. The processing system 805 may be configured to perform processing functions for the communications device 800, including processing signals received and/or to be transmitted by the communications device 800.

The processing system 805 includes one or more processors 810 and a computer-readable medium/memory 830. In various aspects, the one or more processors 810 may be representative of the one or more processors 318 described with respect to FIG. 3. The one or more processors 810 are coupled to a computer-readable medium/memory 830 via a bus 850. In some aspects, the computer-readable medium/memory 830 may be representative of the one or more memories 320 described with respect to FIG. 3. The computer-readable medium/memory 830 is a non-transitory computer-readable medium/memory. In certain aspects, the computer-readable medium/memory 830 is configured to store instructions (e.g., computer-executable code), that when executed by the one or more processors 810, cause the one or more processors 810 to perform the method 600 described with respect to FIG. 6, or any aspect related to it, including any operations described in relation to FIG. 6. Note that reference to a processor performing a function of communications device 800 may include one or more processors performing that function of communications device 800, such as in a distributed fashion.

In the depicted example, computer-readable medium/memory 830 stores code (e.g., executable instructions), including code for receiving 835, code for transmitting 840, and code for calculating 845. Processing of the code 835-845 may enable and cause the communications device 800 to perform the method 600 described with respect to FIG. 6, or any aspect related to it. For instance, in some aspects, code for receiving 835 includes code for receiving a configuration that indicates a reporting metric for a measurement report, the reporting metric comprising at least one of: a rate of change for a parameter, a range of values of the parameter, a frequency of threshold exceedance for the parameter, or a function output based on the parameter. In some aspects, code for transmitting 840 includes code for transmitting the measurement report in accordance with the configuration.

The one or more processors 810 include circuitry configured to implement (e.g., execute) the code stored in the computer-readable medium/memory 830, including circuitry for receiving 815, circuitry for transmitting 820, and circuitry for calculating 825. Processing with circuitry 815-825 may enable and cause the communications device 800 to perform the method 600 described with respect to FIG. 6, or any aspect related to it. For instance, in some aspects, circuitry for receiving 815 includes circuitry for receiving a configuration that indicates a reporting metric for a measurement report, the reporting metric comprising at least one of: a rate of change for a parameter, a range of values of the parameter, a frequency of threshold exceedance for the parameter, or a function output based on the parameter. In some aspects, circuitry for transmitting 820 includes circuitry for transmitting the measurement report in accordance with the configuration.

More generally, means for communicating, transmitting, sending or outputting for transmission may include the one or more transceivers 324, one or more antenna 322 and/or processing system 316 of the UE 304 illustrated in FIG. 3, transceiver 855 and/or antenna 860 of the communications device 800 in FIG. 8, and/or one or more processors 810 of the communications device 800 in FIG. 8. Means for communicating, receiving or obtaining may include the one or more transceivers 324, one or more antennas 322, and/or processing system 316 of the UE 304 illustrated in FIG. 3, transceiver 855 and/or antenna 860 of the communications device 800 in FIG. 8, and/or one or more processors 810 of the communications device 800 in FIG. 8.

FIG. 9 depicts aspects of an example communications device configured for wireless communications. In some aspects, communications device 900 is a network entity, such as BS 102 of FIG. 1, first network entity 300 or second network entity 302 of FIG. 3, or a disaggregated base station as discussed with respect to FIG. 2.

The communications device 900 includes a processing system 905 coupled to a transceiver 955 (e.g., a transmitter and/or a receiver) and/or a network interface 965. The transceiver 955 is configured to transmit and receive signals for the communications device 900 via an antenna 960, such as the various signals as described herein. The network interface 965 is configured to obtain and send signals for the communications device 900 via communications link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910 and a computer-readable medium/memory 930. In various aspects, one or more processors 910 may be representative of the one or more processors 308, as described with respect to FIG. 3. The one or more processors 910 are coupled to the computer-readable medium/memory 930 via a bus 950. In certain aspects, the computer-readable medium/memory 930 is configured to store instructions (e.g., computer-executable code), including code 935-945, that when executed by the one or more processors 910, cause the one or more processors 910 to perform the method 700 described with respect to FIG. 7, or any aspect related to it, including any operations described in relation to FIG. 7. The computer-readable medium/memory 930 is a non-transitory computer-readable medium/memory. Note that reference to a processor of communications device 900 performing a function may include one or more processors of communications device 900 performing that function, such as in a distributed fashion.

In the depicted example, the computer-readable medium/memory 930 stores code (e.g., executable instructions), including code for transmitting 935, code for receiving 940, and code for generating 945. Processing of the code 935-945 may enable and cause the communications device 900 to perform the method 700 described with respect to FIG. 7, or any aspect related to it. For instance, in some aspects, code for transmitting 935 includes code for transmitting, to a wireless communication device, a configuration that indicates a reporting metric for a measurement report, the reporting metric comprising at least one of: a rate of change for a parameter, a range of values of the parameter, a frequency of threshold exceedance for the parameter, or a function output based on the parameter. In some aspects, code for receiving 940 includes code for receiving the measurement report in accordance with the configuration. In some aspects, code for generating 945 includes code for generating, using an AI/ML functionality, an inference based on the measurement report.

The one or more processors 910 include circuitry configured to implement (e.g., execute) the code stored in the computer-readable medium/memory 930, including circuitry for transmitting 915, circuitry for receiving 920, and circuitry for generating 925. Processing with circuitry 915-925 may enable and cause the communications device 900 to perform the method 700 described with respect to FIG. 7, or any aspect related to it. For instance, in some aspects, circuitry for transmitting 915 includes circuitry for transmitting, to a wireless communication device, a configuration that indicates a reporting metric for a measurement report, the reporting metric comprising at least one of: a rate of change for a parameter, a range of values of the parameter, a frequency of threshold exceedance for the parameter, or a function output based on the parameter. In some aspects, circuitry for receiving 920 includes circuitry for receiving the measurement report in accordance with the configuration. In some aspects, circuitry for generating 925 includes circuitry for generating, using an AI/ML functionality, an inference based on the measurement report.

Various components of the communications device 900 may provide means for performing the method 700 described with respect to FIG. 7, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 955, antenna 960, and/or network interface 965 of the communications device 900 in FIG. 9, and/or one or more processors 910 of the communications device 900 in FIG. 9. Means for communicating, receiving or obtaining may include the one or more transceivers 312, one or more antennas 314, and/or processing system 306 of the first network entity 300 or the second network entity 302 illustrated in FIG. 3, transceiver 955, antenna 960, and/or network interface 965 of the communications device 900 in FIG. 9, and/or one or more processors 910 of the communications device 900 in FIG. 9.

### EXAMPLE CLAUSES

Implementation examples are described in the following numbered clauses:

Clause 1: A method for wireless communications by a wireless communication device comprising: receiving a configuration that indicates a reporting metric for a measurement report, the reporting metric comprising at least one of: a rate of change for a parameter, a range of values of the parameter, a frequency of threshold exceedance for the parameter, or a function output based on the parameter; and transmitting the measurement report in accordance with the configuration.

Clause 2: The method of Clause 1, wherein the reporting metric is based on one or more of: a target frequency parameter, a target time parameter, or a target spatial parameter.

Clause 3: The method of any one of Clauses 1-2, wherein the reporting metric is based on a proper subset of parameters of a channel state information report.

Clause 4: The method of any one of Clauses 1-3, wherein the configuration indicates, for the reporting metric, at least one of: a target frequency parameter, a target time parameter, a target spatial parameter, the parameter to which the reporting metric relates, a threshold associated with the frequency of threshold exceedance, a quantity of occurrences, a range of interest, a function for the function output, or a type of sample for the parameter.

Clause 5: The method of any one of Clauses 1-4, wherein the configuration indicates a plurality of reporting metrics for the parameter, and wherein the measurement report comprises the plurality of reporting metrics.

Clause 6: The method of any one of Clauses 1-5, wherein the wireless communication device comprises a network entity, and wherein receiving the configuration comprises receiving the configuration via a backhaul interface, a midhaul interface, or a fronthaul interface.

Clause 7: The method of any one of Clauses 1-6, wherein the configuration indicates a periodicity for calculation of the reporting metric, and wherein the method further comprises calculating the reporting metric in accordance with the periodicity.

Clause 8: The method of any one of Clauses 1-7, wherein the configuration indicates that calculation of the reporting metric is aperiodic or semi-persistent, and wherein the method further comprises calculating the reporting metric in accordance with a trigger.

Clause 9: The method of any one of Clauses 1-8, further comprising transmitting a suggestion for the measurement metric, wherein the configuration is in accordance with the suggestion.

Clause 10: The method of Clause 9, further comprising receiving a request for the suggestion, wherein transmitting the suggestion comprises transmitting the suggestion in accordance with the request.

Clause 11: The method of any one of Clauses 1-10, further comprising transmitting capability information for the measurement report, wherein the configuration is in accordance with capability information.

Clause 12: The method of Clause 11, further comprising receiving a request for the capability information, wherein transmitting the capability information comprises transmitting the capability information in accordance with the request.

Clause 13: The method of any one of Clauses 1-12, wherein the configuration indicates at least one of: a measurement configuration, a reporting frequency, or a reporting resource for the measurement report.

Clause 14: The method of any one of Clauses 1-13, wherein the configuration explicitly indicates to report the parameter and implicitly indicates to report the reporting metric based on explicitly indicating the parameter.

Clause 15: The method of any one of Clauses 1-14, wherein the measurement report comprises at least one of: a conditional handover message, a conditional lower-layer triggered mobility message, or an uplink wakeup signal.

Clause 16: The method of Clause 15, wherein transmitting the measurement report comprises transmitting the measurement report based on a condition, associated with the reporting metric and indicated by the configuration, being satisfied.

Clause 17: The method of any one of Clauses 1-16, wherein the wireless communication device comprises a UE.

Clause 18: The method of any one of Clauses 1-17, wherein the wireless communication device comprises a network entity.

Clause 19: A method for wireless communications by a network entity comprising: transmitting, to a wireless communication device, a configuration that indicates a reporting metric for a measurement report, the reporting metric comprising at least one of: a rate of change for a parameter, a range of values of the parameter, a frequency of threshold exceedance for the parameter, or a function output based on the parameter; receiving the measurement report in accordance with the configuration; and generating, using an AI/ML functionality, an inference based on the measurement report.

Clause 20: The method of Clause 19, wherein the reporting metric is based on one or more of: a target frequency parameter, a target time parameter, or a target spatial parameter.

Clause 21: The method of any one of Clauses 19-20, wherein the reporting metric is based on a proper subset of parameters of a channel state information report.

Clause 22: The method of any one of Clauses 19-21, wherein the configuration indicates, for the reporting metric, at least one of: a target frequency parameter, a target time parameter, a target spatial parameter, the parameter to which the reporting metric relates, a threshold associated with the frequency of threshold exceedance, a quantity of occurrences, a range of interest, a function for the function output, or a type of sample for the parameter.

Clause 23: The method of any one of Clauses 19-22, wherein the configuration indicates a plurality of reporting metrics for the parameter, and wherein the measurement report comprises the plurality of reporting metrics.

Clause 24: The method of any one of Clauses 19-23, wherein the wireless communication device comprises a second network entity, and wherein transmitting the configuration comprises transmitting the configuration via a backhaul interface, a midhaul interface, or a fronthaul interface.

Clause 25: The method of any one of Clauses 19-24, wherein the configuration indicates a periodicity for calculation of the reporting metric.

Clause 26: The method of any one of Clauses 19-25, wherein the configuration indicates that calculation of the reporting metric is aperiodic or semi-persistent, and wherein the method further comprises transmitting a trigger for calculation of the reporting metric.

Clause 27: The method of any one of Clauses 19-26, further comprising receiving a suggestion for the measurement metric, wherein the configuration is in accordance with the suggestion.

Clause 28: The method of Clause 27, further comprising transmitting a request for the suggestion, wherein receiving the suggestion comprises receiving the suggestion in accordance with the request.

Clause 29: The method of any one of Clauses 19-28, further comprising receiving capability information for the measurement report, wherein the configuration is in accordance with capability information.

Clause 30: The method of Clause 29, further comprising transmitting a request for the capability information, wherein receiving the capability information comprises receiving the capability information in accordance with the request.

Clause 31: The method of any one of Clauses 19-30, wherein the configuration indicates at least one of: a measurement configuration, a reporting frequency, or a reporting resource for the measurement report.

Clause 32: The method of any one of Clauses 19-31, wherein the configuration explicitly indicates to report the parameter and implicitly indicates to report the reporting metric based on explicitly indicating the parameter.

Clause 33: The method of any one of Clauses 19-32, wherein the measurement report comprises at least one of: a conditional handover message, a conditional lower-layer triggered mobility message, or an uplink wakeup signal.

Clause 34: One or more apparatuses, comprising: one or more memories comprising executable instructions; and one or more processors configured to execute the executable instructions and cause the one or more apparatuses to perform a method in accordance with any one of Clauses 1-33.

Clause 35: One or more apparatuses configured for wireless communications, comprising: one or more memories; and one or more processors, coupled to the one or more memories, configured to cause the one or more apparatuses to perform a method in accordance with any one of Clauses 1-33.

Clause 36: One or more apparatuses configured for wireless communications, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

Clause 40: One or more apparatuses configured for wireless communications, comprising: a processing system that includes one or more processors and one or more memories coupled with the one or more processors, the processing system configured to cause the one or more apparatuses to perform a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a wireless communication device to:
receive a configuration that indicates a reporting metric for a measurement report, the reporting metric comprising at least one of:
a rate of change for a parameter,
a range of values of the parameter,
a frequency of threshold exceedance for the parameter, or
a function output based on the parameter; and
transmit the measurement report in accordance with the configuration.

2. The apparatus of claim 1, wherein the reporting metric is based on one or more of:
a target frequency parameter,
a target time parameter, or
a target spatial parameter.

3. The apparatus of claim 1, wherein the reporting metric is based on a proper subset of parameters of a channel state information report.

4. The apparatus of claim 1, wherein the configuration indicates, for the reporting metric, at least one of:
a target frequency parameter,
a target time parameter,
a target spatial parameter,
the parameter to which the reporting metric relates,
a threshold associated with the frequency of threshold exceedance,
a quantity of occurrences,
a range of interest,
a function for the function output, or
a type of sample for the parameter.

5. The apparatus of claim 1, wherein the configuration indicates a plurality of reporting metrics for the parameter, and wherein the measurement report comprises the plurality of reporting metrics.

6. The apparatus of claim 1, wherein the wireless communication device comprises a network entity, and wherein to cause the wireless communication device to receive the configuration, the processing system is configured to cause the wireless communication device to receive the configuration via a backhaul interface, a midhaul interface, or a fronthaul interface.

7. The apparatus of claim 1, wherein the configuration indicates a periodicity for calculation of the reporting metric, and wherein the processing system is configured to cause the wireless communication device to calculate the reporting metric in accordance with the periodicity.

8. The apparatus of claim 1, wherein the configuration indicates that calculation of the reporting metric is aperiodic or semi-persistent, and wherein the processing system is configured to cause the wireless communication device to calculate the reporting metric in accordance with a trigger.

9. The apparatus of claim 1, wherein the processing system is configured to cause the wireless communication device to transmit a suggestion for the reporting metric, wherein the configuration is in accordance with the suggestion.

10. The apparatus of claim 9, wherein the processing system is configured to cause the wireless communication device to receive a request for the suggestion, wherein to cause the wireless communication device to transmit the suggestion, the processing system is configured to cause the wireless communication device to transmit the suggestion in accordance with the request.

11. The apparatus of claim 1, wherein the processing system is configured to cause the wireless communication device to transmit capability information for the measurement report, wherein the configuration is in accordance with capability information.

12. The apparatus of claim 11, wherein the processing system is configured to cause the wireless communication device to receive a request for the capability information, wherein to cause the wireless communication device to transmit the capability information, the processing system is configured to cause the wireless communication device to transmit the capability information in accordance with the request.

13. The apparatus of claim 1, wherein the configuration indicates at least one of:
a measurement configuration,
a reporting frequency, or
a reporting resource for the measurement report.

14. The apparatus of claim 1, wherein the configuration explicitly indicates to report the parameter and implicitly indicates to report the reporting metric based on explicitly indicating the parameter.

15. The apparatus of claim 1, wherein the measurement report comprises at least one of:
a conditional handover message,
a conditional lower-layer triggered mobility message, or
an uplink wakeup signal.

16. The apparatus of claim 15, wherein to cause the wireless communication device to transmit the measurement report, the processing system is configured to cause the wireless communication device to transmit the measurement report based on a condition, associated with the reporting metric and indicated by the configuration, being satisfied.

17. The apparatus of claim 1, wherein the wireless communication device comprises a user equipment (UE).

18. The apparatus of claim 1, wherein the wireless communication device comprises a network entity.

19. An apparatus for wireless communications, comprising a processing system that includes one or more processors and one or more memories coupled with the one or more processors, the processing system configured to cause a network entity to:
transmit, to a wireless communication device, a configuration that indicates a reporting metric for a measurement report, the reporting metric comprising at least one of:
a rate of change for a parameter,
a range of values of the parameter,
a frequency of threshold exceedance for the parameter, or
a function output based on the parameter;
receive the measurement report in accordance with the configuration; and
generate, using an artificial intelligence or machine learning (AI/ML) functionality, an inference based on the measurement report.

20. A method of wireless communication by a wireless communication device, comprising:
receiving a configuration that indicates a reporting metric for a measurement report, the reporting metric comprising at least one of:
a rate of change for a parameter,
a range of values of the parameter,
a frequency of threshold exceedance for the parameter, or
a function output based on the parameter; and
transmitting the measurement report in accordance with the configuration.
